(19) United States
(12) Patent Application Publication
(10) Pub. No.: US 2009/0310525 A1
(43) Pub. Date: Dec. 17, 2009

(54) METHOD AND NETWORK ENTITIES FOR SYNCHRONIZING RADIO COMMUNICATION

(76) Inventors: Volker Breuer, Botzow (DE); Demain Martos-Riano, Berlin (DE); Thomas Ulrich, Bad Durkheim (DE)

Correspondence Address: STAAS & HALSEY LLP, SUITE 700, 1201 NEW YORK AVENUE, N.W., WASHINGTON, DC, 20005, US

(21) Appl. No.: 12/310,402

(22) PCT Filed: Aug. 7, 2007
(86) PCT No.: PCT/EP2007/058196

§ 371 Date: Aug. 11, 2009

(30) Foreign Application Priority Data
Aug. 24, 2006 (EP) 06017660.9

(51) Int. Cl. H04H 20/71

(52) U.S. Cl. 370/312

(57) ABSTRACT

At least one mobile station receives information from at least one first radio network node serving radio cells providing multicast communication and communicates with at least one second radio network node serving radio cells providing unicast communication. Information regarding multicast communication is transmitted from the at least one mobile station to the at least one second radio network node and the at least one first radio network node via at least one connection established between the first and the second network node.

### CROSS REFERENCE TO RELATED APPLICATIONS

This application is based on and hereby claims priority to European Application No. 06017660 filed on Aug. 24, 2006, the contents of which are hereby incorporated by reference.

### BACKGROUND

Described below is a method and network entities, e.g. a radio network node like a base station or a network controller and mobile stations, for synchronizing radio communication, wherein at least one mobile station receives information from at least one first radio network node serving radio cells providing multicast communication and communicates with at least one second radio network node serving radio cells providing unicast communication.

This method is particularly used in the field of mobile radio communications, for their future evolution.

For the evolved Packet Core and the evolved UTRAN being currently discussed in standardization activities like 3GPP (Third Generation Partnership Project). So-called MBMS (Multimedia Broadcast Multicast Services) is seen as a key feature of the future mobile/cellular communications system.

Multimedia Broadcast Multicast Service (MBMS) is a broadcasting service that can be offered via existing GSM and UMTS cellular networks. The infrastructure offers an option to use an uplink channel for interaction between the service and the user, which is not a straightforward issue in usual broadcast networks, as for example digital television is only a one-way (unidirectional) system. MBMS uses multicast distribution in the core network instead of point-to-point links for each end (user) device.

In addition, in eUTRAN (i.e. LTE) MBMS shall be offered enabling soft or selective combining at the mobile station (UE), in order to improve the efficiency at the cell border. This requires high downlink synchronization accuracy. The same MBMS service broadcasted from different nodes is synchronized with a high accuracy, suited for macro diversity combining in the UEs. In OFDM systems, UE manufacturers postulate a synchronization accuracy of no less than the Cyclic Prefix of the OFDM symbol; in this way a UE in the field will be able to perform soft combining of the data streams provided by different NodeBs. If in addition a spectrum chunk of carrier is in use for MBMS and not used for any unicast service, all received signals can be constructively combined, given that DL transmissions from different NodeBs are bit-identically encoded. Therefore, provisioning of the MBMS service in DL is coverage limited only, according to the reach of the radio signals and the possibility to combine several from different sources, and not interference limited as it is the case in DL for unicast services. This is in opposite to UMTS where the DL is in general interference or (capacity limited) due to the nature of CDMA being a compound of a code stack.

For instant, FIG. 1 shows a soft or selective combining at the UE (described as combining areas e.g. S1+S3, S3+S2, S1+S2, S1+S2+S3) of two or three identical signals S1, S2, S3 from different eNBs serving radio cells S1 cell, S2 cell and S3 cell within a mobile radio communications network.

Due to the high available BS power and support of selective or soft combining at the UE, the MBMS coverage area of a network node, e.g. BS/NodeB, can be far larger than its normal coverage area for unicast services as shown in FIG. 1.

For this reason, MBMS services may be offered over a Single Frequency Layer (SFL) in the network, used in DL from a reduced number of base stations with high transmission power capacity.

For example, in order to offer mobile TV over MBMS, the following scenario can be expected: coverage-driven rollout of mobile TV over a large geographical area (entire city, region, or even country), using a single LTE frequency chunk/band; few Node Bs, in comparison with the total amount of deployed Node Bs, would be required to broadcast the service (coverage limited and not interference limited in the DL); the UL channel for the UEs shall anyway be ensured in its own cell, a cell not necessarily assigned to the Node B offering the MBMS service). The bigger the broadcasted area, the higher the probability that the number of interested (mobile TV watching) customers is sufficiently high and justifies the use of PtM (Point to Multipoint) broadcasting.

However, the problem of the feedback from the UE to the system in the UL and its lower reach, due to lower UE power shall be solved.

In this context some relevant mechanisms should be introduced which involves
Communication between eNBs (evolved-Node Bs) in eUTRAN for MBMS purposes and related definition of interfaces between eNBs.
Decision mechanisms at eNBs in order to provide MBMS in an efficient way, in terms of appropriate coverage and use of radio resources.
Coordination of radio resources between evolved Node Bs for MBMS purposes.

Use of the presented method is not restricted to MBMS over UTRAN. Broadcast and Multicast Services may be delivered over other existing technologies which are not necessarily related to mobile communications, such as DAB DMB (T-DMB is an ETSI standard, DVB: DVB-T and especially DVB-H for Handhelds).

In UTRAN, these mechanisms, which are especially relevant for Multicast, are coordinated at the RNC. This approach is not applicable in eUTRAN because there is/will not be any central node in the network anymore.

In eUTRAN, it is possible to have a very similar approach as in UTRAN if selected eNBs (such as MBMS capable ones) are treated as central MBMS nodes and assume RNC-like MBMS functions.

It is relevant to analyze how the uplink channel from the UE to the MBMS system is meant to be provided in e.g., DVB-H. Using a mobile communications network is already a common approach for this purpose, however the relation between radio cells of one system and the other may have not been taken into account.

### SUMMARY

An aspect is to improve the above mentioned MBMS delivery approach.

Another aspect is that information regarding multicast communication is transmitted from the at least one mobile station to the at least one second radio network node and the at least one first radio network node via at least one connection established between the first and second network node.

The multicast communication may provide multimedia broadcast multicast services.

Above all this brings about the advantage that broadband- and multicast services, in particular data-intensive services like MBMS, could be efficiently provided for a great deal of user equipments. This would make DL as well as UL communication available in an economic manner.

According to a further embodiment, the information regarding multicast communication further includes paging information and/or user counting information and/or multicast service indication.

In the case that the mobile radio communications network is structured by multiple radio cell layers served by at least one radio network node, the at least one connection being established in any one of the radio cell layers could be supported by radio resources of any other radio cell layer.

The at least one connection may be supported by radio resources from at least one neighboring radio cell providing unicast communication and/or providing multicast communication.

It is further advantageous if the radio resources from at least one neighboring radio cell are chosen towards which the mobile station is moving.

The presented method can be applied in order to provide an uplink from the UE to the MBMS system over the mobile network.

The MBMS content may be provided by MBMS cells where as counting and MBMS service indication will be a task fulfilled by NodeBs being in a lower layer structure to overcome the limited feedback possibilities of the UE and the need to listen for service indication to separate reserved MBMS frequency or data chunks.

Also described below are network entities, e.g. a radio network node like a base station and a mobile station for radio communication and for performing the above mentioned method.

A radio network node, such as the second radio network node performing the above mentioned method, receives information regarding multicast communication from the at least one mobile station and forwards the information to the at least one further first network node via at least one connection established between them.

A radio network node, such as the first radio network node performing the above mentioned method, receives information regarding multicast communication from at least one further second network node via at least one connection established between them.

A mobile station performing the above mentioned method transmits information regarding multicast communication to the at least one second radio network node and the at least one first radio network node via at least one connection established between the first and the second network node.

As described below, a radio communications network includes at least one radio network node and at least one mobile station.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic diagram a soft or selective combining at the user device,

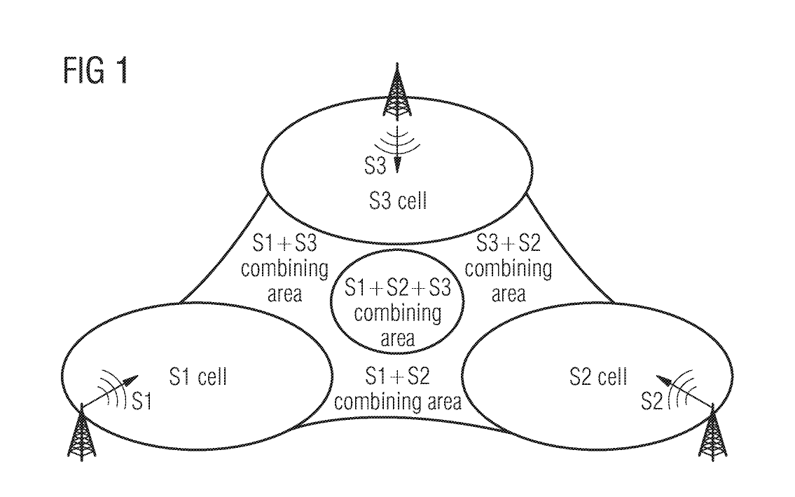

FIG. 2 is a schematic diagram depicting an MBMS coverage area versus a unicast (voice) coverage area,

FIG. 3 is a schematic structure of a three-layered, hierarchical cell ordering with increasing cell sizes.

### DETAILED DESCRIPTION OF THE PREFERRED EMBODIMENTS

Reference will now be made in detail to the exemplary embodiments, examples of which are illustrated in the accompanying drawings, wherein like reference numerals refer to like elements throughout.

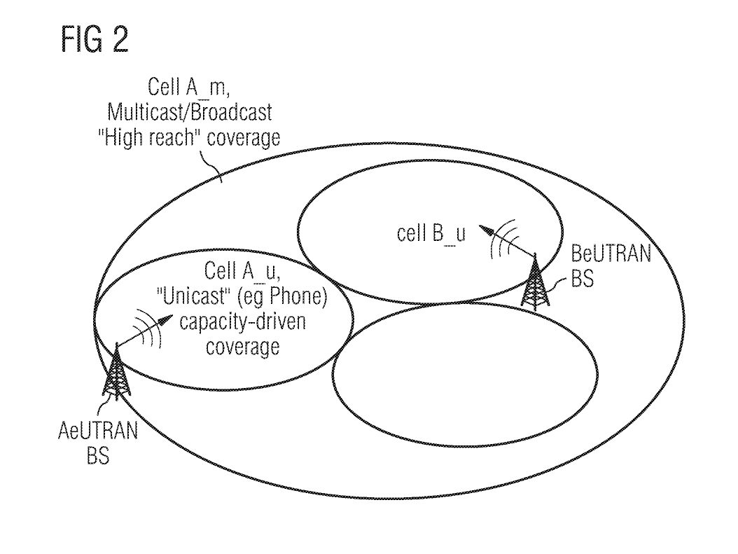

FIG. 2 generally shows an eUTRAN Base station A serving radio cells Cell A_m (MBMS coverage) and Cell A_u (Unicast coverage). It is illustrated a further eUTRAN Base station B serving Cell B_u (Unicast coverage). Additionally a further cell is shown with no special allocation to any of the depicted elements.

The illustrated MBMS coverage area from A overlaps Cell A_u as well as Cell B_u.

In contrast with UTRAN, where there is a RAN central node, the RNC, in eUTRAN there is no central node, whether for user plane or control purposes. Any activity like MBMS requiring coordination between several base stations requires signalling between them. Below we outline a coordination strategy fulfilling the purposes of MBMS.

For most of the mobile services, the network roll-out is capacity-driven and involves small cells building a dense coverage. This is an interesting contrast with the MBMS roll-out, coverage-driven, or very large cells.

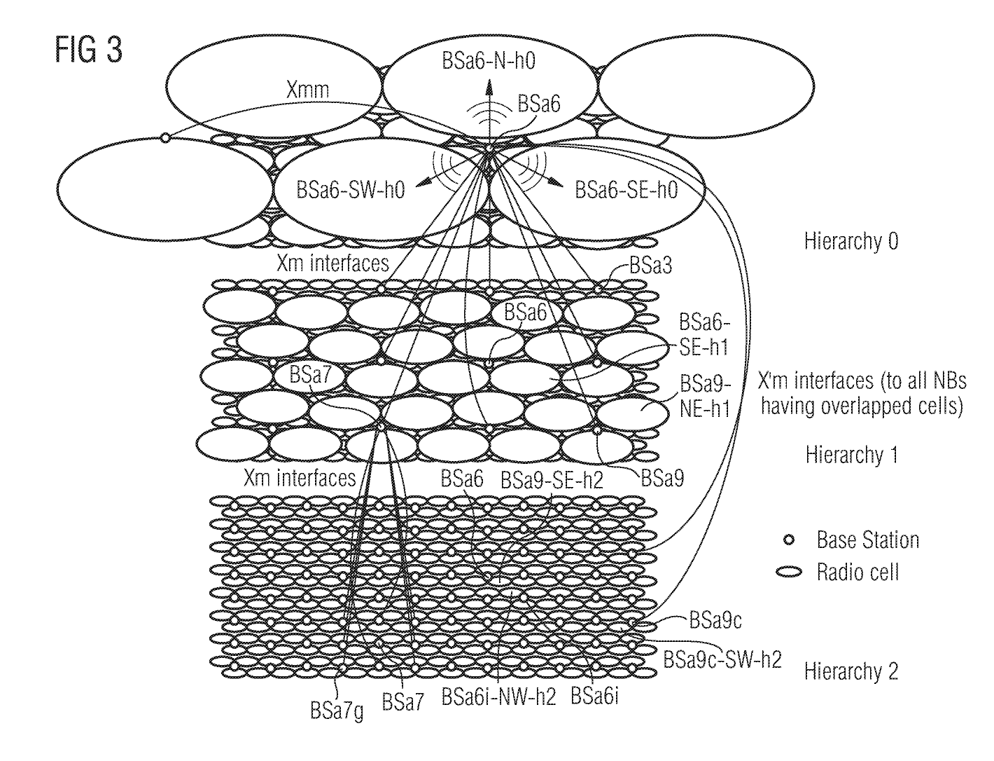

Considering the base stations and their provided cells in a network, for the purpose of MBMS, a hierarchical cell organization is configured as represented in FIG. 3.

FIG. 3 generally depicts MBMS Hierarchical Cell Ordering.

It is shown three hierarchical cell layers Hierarchy 0, Hierarchy 1 and Hierarchy 2 with radio cells having different sizes depending on their associated hierarchical layer. A Base station e.g. BSa6 could serve several radio cells of various hierarchical layers. The radio cells of the layers are marked with signs, particularly as described below. Furthermore some so-called X-interfaces e.g. Xmm, Xm X′m among at least two base stations are depicted.

The hierarchical cell organization is established according to the “topographically” overlapping conditions between cells of different sizes. A proper radio network planning and configuration (or self-configuration) (addressing MBMS services should address complete overlapping of one cell by another of a higher hierarchical level. This is a subordinating relationship that will be called “MBMS Cell Subordination” of the cell of lower hierarchy (and smaller size) to the cell of higher hierarchy (and bigger size). This relation is inherited over the hierarchy line. As an example, in FIG. 3, the cell BSa9c-SW-h2 is overlapped by BSa9-NE-h1, which in turn is overlapped by Bsa6-SE-h0 (h0 denotes the highest hierarchy, and in the described example h1 is an intermediate hierarchy while h2 is the lowest hierarchy). BSa9c-SW-2 is subordinated to both BSa9c-NE-h1 and Bsa6-SE-h0, while BSa9c-NE-h1 is subordinated to BSa9c-NE-h2. These relations are static ones, established at the time of the cell configuration (or self-configuration) of the network, or else detected (and optimized) automatically. MBMS relies then on an ordered hierarchical cell structure, or HCO (Hierarchical Cell Ordering).

For multicast purposes, and according to the presence of interested recipients in the different lowest-hierarchical cell area, the decisions regarding how to reach them in a way that is the most efficient in terms of radio efficiency are various:
MBMS over a combination of cells of different hierarchies.
MBMS over a scattered group of cells of the same hierarchy, with special attention to those cases where the UE is at cell border.
MBMS over cells of the same hierarchy forming a convex area.

For example, a broadcast service meant for a given geographical area would be offered from the highest hierarchy, selecting cells covering the intended area. In terms of radio network configuration (or self-configuration), the MBMS coverage shall coincide with the intended geographical area

The decision is taken according to the information available and retrievable about the interested recipients. The information serves the purposes of
Counting interested recipients per cell, with special attention of those close to the edge of the cell.
Enabling Soft or selective combining for specific UEs, using MBMS activation at several cells simultaneously.
Checking additional reception information (e.g. actual interest in immediate reception).

For broadcast purposes, according to the targeted local MBMS Broadcast service area/Local Broadcast Area, it is not necessary to perform any localization of the interested users, and the transmission takes place at MBMS cells pre-selected according to the service and related broadcast areas. However, coordination is still required for proper Radio Resources reservation for the purpose of the broadcast, according to the existing HCO.

The UL link of the UE, which will serve for information exchange purposes with RAN, shall be established over the best cell which is the serving cell or the cell the UE is located and is in general the smallest cell providing coverage (i.e. belongs to the lowest hierarchy level), and acts as what we call an UL-relay cell.

In LTE, there is no centralized node like in UTRAN and this information needs to be exchanged between Node Bs in a fashion that reflects the described subordination. For this purpose, following interfaces can be defined at this stage:
Xmm, which interconnects two eNBs belonging to the same hierarchy level that share a border area.
Interface X′m_i (where i is an integer) between eNBs, an eNB “I” that manages a lower hierarchy cell with respect to a higher hierarchy cell, and the eNB “h” which manages the mentioned higher hierarchy cell. i is the hierarchy level degree difference between the cells.
Xm, which is equivalent to X′m_1.

The Xmm interface interconnects eNBs with cells sharing a border. Since MBMS in LTE requires accurate synchronization between this kind of cells, this interface makes primarily sense for those eNBs that are MBMS-capable. This interface serves the purpose of coordinated (in particular with respect to Soft Handover) MBMS. This involves coordination of MBMS content broadcast/multicast according to time and frequency radio resources, using the established synchronization. In addition, this interface could serve MBMS-specific mobility management mechanisms.

For a given eNB that manages a higher hierarchy cell c_h, the X′m_i interfaces connect to him in a star fashion all eNBs managing those cells hierarchically subordinated to c_h. The interface Xm interconnects eNBs in a tree reflecting the hierarchical relationship between cells.

The X′m_i interface serves the purpose of:
1. Providing information “hierarchy upwards” on UEs interested in a certain MBMS, for counting & other purposes.
2. Indicating decision “hierarchy downwards” on accepting/refusing to take over MBMS towards interested UEs in the affected cells.

It is relevant to indicate that this is affecting lower-hierarchy cells that are not serving any interested UE, but shall lend radio resources for the higher-level hierarchy cell's MBMS.

Information is provided “hierarchy upwards” with i=1, also as a mean to consolidate the information that is relevant for a decision.

Decision is provided “hierarchy downwards” with i=1, however indicating to the lowest hierarchy level cell which eNB takes over the MBMS delivery.

The decision of accepting to take over MBMS towards UEs in a lower-hierarchy cell has also an associated RRM (=Radio Resource Management) configuration (or self-configuration) between both cells with respect to the radio resources necessary for the MBMS. This RRM configuration (or self-configuration) is based in sharing the “resources for disposition”. Two approaches are possible:
The resources are owned by the lowest hierarchy level cell, and these are lent to the higher-hierarchy cell that has accepted to take over the MBMS for the interested UEs, and returned upon MBMS Session completion.
The other way round: resources are owned by the higher hierarchy cell, and in case lower-hierarchy cells broadcast MBMS, RRM resources are lent, and returned upon MBMS Session completion.

Both approaches seem to be justified for different, equally relevant RRM strategies.

Additional Improvements

A) In order to improve coverage and mobility conditions, when a lower-hierarchy cell informs on the presence of interested UEs at it, then the higher level hierarchy cell shall also take into consideration providing MBMS at neighboring cells. This implies that mechanisms are provided in order to:
Inform lower-hierarchy cells, which MBMS services will be offered in their area.
Proceed to necessary RRM allocation as described previously.
Inform neighboring lower-hierarchy cells, which MBMS services are potentially offered.
   B) The decision on how to offer an MBMS is based on the position of the UEs at a given point in time. Since UEs move, the situation changes and the old decision may become obsolete. The update of this information can be based on following strategies:
The UL-relay cell at which the lowest-hierarchy level is, notices relevant changes regarding the UE, and informs “hierarchy upwards”.
The serving MBMS eNB may request from lowest-hierarchy cells an update on the situation. This is performed not only towards UP-relay cells of UE being serviced, but from lower-hierarchy cells in general to which interested cells may have moved in or turned on.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to exemplary embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for synchronizing radio communication within a mobile radio communications network, comprising:
receiving, by at least one mobile station, information from at least a first radio network node serving first radio cells providing multicast communication;
communicating, by the at least one mobile station, with at least a second radio network node serving second radio cells providing unicast communication;
transmitting information regarding multicast communication from the at least one mobile station to at least the first and second radio network nodes via at least one connection established between at least the first and second radio network nodes.

12. A method as claimed in claim 11, wherein the multicast communication provides multimedia broadcast multicast services.

13. A method as claimed in claim 12, wherein the information regarding multicast communication includes at least one of paging information, user counting information and a multicast service indication.

14. A method as claimed in claim 13,
wherein the mobile radio communications network is structured by multiple radio cell layers served by at least one radio network node, and
wherein the at least one connection is established in any one of the multiple radio cell layers and is supported by radio resources of any other radio cell layer.

15. A method as claimed in claim 14, wherein the at least one connection is supported by radio resources from at least one neighboring radio cell providing at least one of unicast communication and multicast communication.

16. A method as claimed in claim 15, wherein the radio resources from the at least one neighboring radio cell are chosen towards which the mobile station is moving.

17. A radio network node synchronizing radio communication within a mobile radio communications network including at least one mobile station which receives information from at least one other radio network node serving radio cells providing multicast communication, comprising:
means for receiving information regarding multicast communication from the at least one mobile station; and
means for forwarding the information to the at least one other network node via at least one connection established therewith.

18. A radio network node synchronizing radio communication within a mobile radio communications network including at least one mobile station and at least one other radio network node serving radio cells providing unicast communication, comprising:
means for establishing at least one connection with the at least one other network node; and
means for receiving information regarding multicast communication from the at least one other network node via the at least one connection established therewith.

19. A mobile station synchronizing radio communication within a mobile radio communications network including at least a first radio network node serving first radio cells providing multicast communication and at least a second radio network node serving second radio cells providing unicast communication, comprising:
means for establishing at least one connection with at least the first and second radio network nodes; and
means for transmitting information regarding multicast communication to at least the first and second radio network nodes via the at least one connection established between at least the first and second radio network nodes.

20. A radio communications network synchronizing radio communication between first radio cells providing multicast communication and second radio cells providing unicast communication, comprising:
at least a first radio network node serving the first radio cells;
at least a second radio network node serving the second radio cells; and
at least one mobile station transmitting information regarding multicast communication received from at least the first radio network node to at least the second radio network node via at least one connection established between at least the first and second radio network nodes.
